(19) United States
(12) Patent Application Publication
(10) Pub. No.: US 2026/0045268 A1
(43) Pub. Date: Feb. 12, 2026

(54) Unsupervised Speaker Diarization Using a Latent Speaker Bottleneck Module

(71) Applicant: Google LLC, Mountain View, CA (US)

(72) Inventors: Jason Pelecanos, Mountain View, CA (US); Yiling Huang, Edgewater, NJ (US); Quan Wang, Hoboken, NJ (US)

(73) Assignee: Google LLC, Mountain View, CA (US)

(21) Appl. No.: 18/797,186

(22) Filed: Aug. 7, 2024

(51) Int. Cl. G10L 21/028; G10L 17/02; G10L 17/04; G10L 25/78

(52) U.S. Cl. CPC G10L 21/028; G10L 17/02; G10L 17/04; G10L 25/78

(57) ABSTRACT

A method includes receiving audio data characterizing a conversation between two or more speakers. The method also includes generating a sequence of audio features based on the audio data. For each output step of a plurality of output steps, the method includes generating a corresponding set of embeddings for the corresponding audio features, selecting a subset of the embeddings for the corresponding output step from the corresponding set of embeddings, and predicting a respective voice activity indicator for each respective speaker of the two or more speakers based on the subset of the embeddings selected for corresponding output step. The respective voice activity indicator indicates whether a voice of the respective speaker is active or inactive at the corresponding output step.

### TECHNICAL FIELD

This disclosure relates to unsupervised speaker diarization using a latent speaker bottleneck module.

### BACKGROUND

Speaker diarization is the process of partitioning an input audio stream into homogeneous segments according to speaker identity. In an environment with multiple speakers, speaker diarization answers the question “who is speaking when” and has a variety of applications including multimedia information retrieval, speaker turn analysis, audio processing, and automatic transcription of conversational speech to name a few. For example, speaker diarization involves the task of annotating speaker turns in a conversation by identifying that a first segment of an input audio stream is attributable to a first human speaker (without particularly identifying who the first human speaker is), a second segment of the input audio stream is attributable to a different second human speaker (without particularly identifying who the second human speaker is), a third segment of the input audio stream is attributable to the first human speaker, etc.

### SUMMARY

One aspect of the disclosure provides a speaker diarization model that includes a diarization encoder, a latent speaker bottleneck module (LSBM), and a diarization decoder. The diarization encoder is configured to receive, as input, audio data characterizing a conversation between two or more speakers and generate a sequence of audio features based on the audio data. The LSBM is configured to receive, as input, the sequence of audio features generated by the diarization encoder and, for each of a plurality of output steps, generate a corresponding set of embeddings for the corresponding output step and select a subset of the embeddings for the corresponding output step from the corresponding set of embeddings. The diarization decoder is configured to receive the subset of the embeddings selected by the LSBM and, for output step, predict a respective voice activity indicator for each respective speaker of the two or more speakers based on the subset of the embeddings selected for the corresponding output step. Here, the respective voice activity indicator indicates whether a voice of the respective speaker is active or inactive at the corresponding output step.

Implementations of the disclosure may include one or more of the following optional features. In some implementations, the diarization encoder is further configured to sample one or more audio features from the sequence of audio features and generate auxiliary information based on the sampled one or more audio features. In these implementations, the diarization decoder may be further configured to concatenate the subset of embeddings selected by the LSBM with the auxiliary information generated by the diarization encoder. Here, the diarization decoder predicts the respective voice activity indicator for each respective speaker of the two or more speakers further based on the concatenation

In some examples, using a training process, the speaker diarization model is trained on unlabeled training samples each including a sequence of speech features. Here, for each respective speech feature the training process includes, generating, using the speaker diarization model, a corresponding reconstructed speech feature, determining a mean square error loss based on the respective speech feature and the corresponding reconstructed speech feature, and training the speaker diarization model end-to-end on the mean square error loss. In these examples, after training the speaker diarization model on the mean square error loss the training process trains the LSBM on labeled training samples each paired with a corresponding ground truth label. Here, for each respective labeled training sample, the training process includes generating, using the diarization encoder, a corresponding sequence of audio features, generating, using the LSBM, a corresponding set of embeddings based on the corresponding sequence of audio features, and generating, using the LSBM, a corresponding weight for each respective embedding of the corresponding set of embeddings. For each respective labeled training sample the training process may further include determining a selection loss based on the corresponding weight generated for each respective embedding of the corresponding set of embeddings and the corresponding ground truth label and training the LSBM on the selection loss to teach the LSBM to generate binary weights. In these examples, for each respective labeled training sample, the training process may further include determining a weight variance loss based on adjacent pairs of corresponding sets of weights and training the LSBM on the weight variance loss to teach the LSBM to not update the corresponding weight generated for each respective embedding of the corresponding set of embeddings when no speaker turn occurs.

In some implementations, using a training process, the speaker diarization model generates labeled training data for speaker diarization from unlabeled training data, the training process, using the labeled training data, teaches another model to learn speaker diarization. At least a portion of the audio data may include overlapping speech. In some examples, a number of the two or more speakers is unknown when the audio data is received.

Another aspect of the disclosure provides a computer-implemented method executed on data processing hardware that causes the data processing hardware to perform operations for performing unsupervised speaker diarization. The operations include receiving, as input to a speaker diarization model, audio data characterizing a conversation between two or more speakers. The operations also include generating a sequence of audio features based on the audio data using a diarization encoder of the speaker diarization model. At each output step of a plurality of output steps, the operations include: generating a corresponding set of embeddings for the corresponding output step using a latent speaker bottleneck module (LSBM) of the speaker diarization model; selecting a subset of the embeddings for the corresponding output step from the corresponding set of embeddings; and predicting, using a diarization decoder of the speaker diarization model, a respective voice activity indicator for each respective speaker of the two or more speakers based on the subset of the embeddings selected for the corresponding output step. Here, the respective voice activity indicator indicates whether a voice of the respective speaker is active or inactive at the corresponding output step.

Implementations of the disclosure may include one or more of the following optional features. In some implementations, the operations further include sampling, using the diarization encoder, one or more audio features from the sequence of audio features and generating, using the diarization encoder, auxiliary information based on the sampled one or more audio features. In these implementations, the operations may further include concatenating, using the diarization decoder, the subset of embeddings selected by the LSBM with the auxiliary information generated by the diarization encoder. Here, wherein predicting the respective voice activity indicator for each respective speaker of the two or more speakers is further based on the concatenation.

In some examples, the operations further include training the speaker diarization model on unlabeled training samples each including a sequence of speech features by, for each respective speech feature: generating, using the speaker diarization model, a corresponding reconstructed speech feature; determining a mean square error loss based on the respective speech feature and the corresponding reconstructed speech feature; and training the speaker diarization model end-to-end on the mean square error loss. In these examples, after training the speaker diarization model on the mean square error loss, the operations may further include training the LSBM on labeled training samples each paired with a corresponding ground truth label by, for each respective labeled training sample: generating, using the diarization encoder, a corresponding sequence of audio features; generating, using the LSBM, a corresponding set of embeddings based on the corresponding sequence of audio features; and generating, using the LSBM, a corresponding weight for each respective embedding of the corresponding set of embeddings. For each respective labeled training sample, the operations may further include determining a selection loss based on the corresponding weight generated for each respective embedding of the corresponding set of embeddings and the corresponding ground truth label and training the LSBM on the selection loss to teach the LSBM to generate binary weights. In these example, for each respective labeled training sample, the operations may further include determining a weight variance loss based on adjacent pairs of corresponding sets of weights and training the LSBM on the weight variance loss to teach the LSBM to not update the corresponding weight generated for each respective embedding of the corresponding set of embeddings when no speaker turn occurs.

In some implementations, the operations further include generating, using the speaker diarization model, labeled training data for speaker diarization from unlabeled training data and training another model to learn speaker diarization using the labeled training data. At least a portion of the audio data may include overlapping speech. In some examples, a number of the two or more speakers is unknown when the audio data is received.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system that executes an automatic speech recognition model and a diarization model.

FIG. 2 is a schematic view of an example automatic speech recognition model.

FIG. 3 is a schematic view of an example training process of training the diarization model.

FIG. 4 is a flowchart of an example arrangement of operations for a computer-implemented method of performing unsupervised speaker diarization using a latent speaker bottleneck module.

FIG. 5 is a schematic view of an example computing device that may be used to implement the systems and methods described herein.

Like reference symbols in the various drawings indicate like elements.

### DETAILED DESCRIPTION

Automatic speech recognition (ASR) systems generally rely on speech processing algorithms that assume only one speaker is present in a given input audio signal. An input audio signal that includes a presence of multiple speakers can potentially disrupt these speech processing algorithms, thereby leading to inaccurate speech recognition results output by the ASR systems. As such, speaker diarization is the process of segmenting speech from a same speaker in a larger conversation to not specifically determine who is talking (speaker recognition/identification), but rather, determine when someone is speaking. Put another way, speaker diarization includes a series of speaker recognition tasks with short utterances and determines whether two segments of a given conversation were spoken by the same individual or different individuals, and repeated for all segments of the conversation.

Existing speaker diarization systems generally include multiple relatively independent components, such as, without limitation, a speech segmentation module, an embedding extraction module, and a clustering module. The speech segmentation module is generally configured to remove non-speech parts from an input utterance and divide the input utterance into small fixed-length segments, while the embedding extraction module is configured to extract, from each fixed-length segments, a corresponding speaker-discriminative embedding. The speaker-discriminative embeddings may include i-vectors or d-vectors. The clustering modules employed by the existing speaker diarization systems are tasked with determining the number of speakers present in the input utterance and assign speaker identifiers (e.g., labels) to each fixed-length segment. These clustering modules may use popular clustering algorithms that include Gaussian mixture models, mean shift clustering, agglomerative hierarchical clustering, k-means clustering, links clustering, and spectral clustering. Speaker diarization systems may also use an additional re-segmentation module for further refining of the diarization results output from the clustering module by enforcing additional constraints.

These existing speaker diarization systems are limited by the fact that the extracted speaker-discriminative embeddings are not optimized for diarization, and therefore may not necessarily extract relevant features for disambiguating speakers in the presence of overlap. Moreover, the clustering modules operate in an unsupervised manner such that all speakers are assumed to be unknown and the clustering algorithm needs to produce new “clusters” to accommodate the new/unknown speakers for every new input utterance.

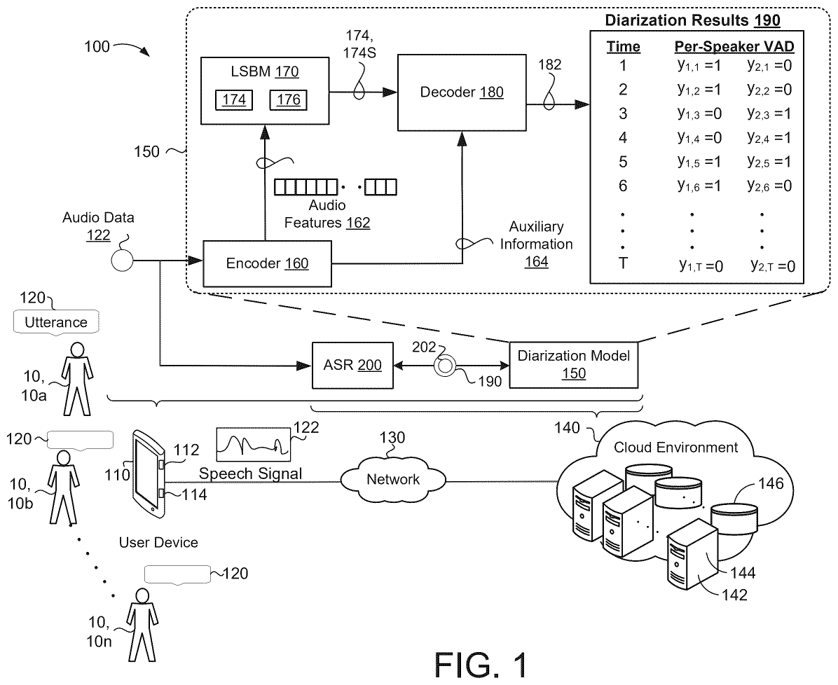

Referring to FIG. 1, a system 100 includes a user device 110 capturing speech utterances 120 from a group of multiple speakers (e.g., users) 10, 10a-n and communicating with a remote system 140 via a network 130. The remote system 140 may be a distributed system (e.g., cloud computing environment) having scalable/elastic resources 142. The resources 142 include computing resources 144 (e.g., data processing hardware) and/or storage resources 146 (e.g., memory hardware). In some implementations, the user device 110 and/or the remote system 140 executes a diarization model 150 that is configured to receive an input audio signal (i.e., audio data) 122 that corresponds to the captured utterances 120 from the multiple speakers 10 and generate corresponding diarization results 190.

The user device 110 includes data processing hardware 112 and memory hardware 114. The user device 110 may include an audio capture device (e.g., microphone) for capturing and converting the speech utterances 120 from the speakers 10 into the audio data 122 (e.g., electrical signals). In some implementations, the data processing hardware 112 is configured to execute a portion of the diarization model 150 locally while a remaining portion of the diarization model 150 executes on the remote system 140. Alternatively, the data processing hardware 112 may execute the diarization model 150 in lieu of executing the diarization model 150 on the remote system 140. The user device 110 can be any computing device capable of communicating with the remote system 140 through the network 130. The user device 110 includes, but is not limited to, desktop computing devices and mobile computing devices, such as laptops, tablets, smart phones, smart speakers/displays, smart appliances, internet-of-things (IoT) devices, and wearable computing devices (e.g., headsets and/or watches). The user device 110 may optionally execute an automatic speech recognition (ASR) model 200 to transcribe the audio data 122 into corresponding text 202. For instance, when network communications are down or not available, the user device 110 may execute the diarization model 150 and/or the ASR model 200 locally to produce the diarization results 190 for the audio data 122 and/or generate a transcription 202 of the audio data 122.

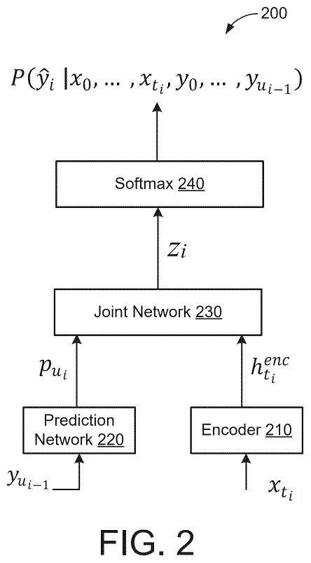

Referring to FIG. 2, an example ASR model 200 includes a Recurrent Neural Network-Transducer (RNN-T) model architecture which adheres to latency constraints associated with interactive applications. The use of the RNN-T model architecture is exemplary, and the ASR model 200 may include other architectures such as transformer-transducer and conformer-transducer model architectures among others. The RNN-T model architecture provides a small computational footprint and utilizes less memory requirements than conventional ASR architectures, making the RNN-T model architecture suitable for performing speech recognition entirely on the user device 102 (e.g., no communication with a remote server is required). The RNN-T model architecture of the ASR model 200 includes an encoder network 210, a prediction network 220, and a joint network 230. The encoder network (i.e., audio encoder) 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the audio encoder 210 reads a sequence of d-dimensional feature vectors (e.g., audio data 122 (FIG. 1) x=(x₁, x₃, . . . , x_{T}), where xₜ∈R_{d}, and produces at each output step a higher-order feature representation. This higher-order feature representation is denoted as

$${h}_{1}^{enc} , … , {h}_{T}^{enc} .$$

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P(yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values can be a vector and can indicate a probability distribution over the set of output labels. In some cases, the output labels are graphemes (e.g., individual characters, and potentially punctuation and other symbols), but the set of output labels is not so limited. For example, the set of output labels can include wordpieces, phonemes, and/or entire words, in addition to or instead of graphemes. The output distribution of the joint network 230 can include a posterior probability value for each of the different output labels. Thus, if there are 100 different output labels representing different graphemes or other symbols, the output yᵢ of the joint network 230 can include 100 different probability values, one for each output label. The probability distribution can then be used to select and assign scores to candidate orthographic elements (e.g., graphemes, wordpieces, and/or words) in a beam search process (e.g., by the Softmax layer 240) for determining the transcription 202.

The Softmax layer 240 may employ any technique to select the output label/symbol with the highest probability in the distribution as the next output symbol predicted by the ASR model 200 at the corresponding output step. In this manner, the ASR model 200 does not make a conditional independence assumption, rather the prediction of each symbol is conditioned not only on the acoustics but also on the sequence of labels output so far. The ASR model 200 does assume an output symbol is independent of future audio data 122, which allows the ASR model 200 to be employed in a streaming fashion.

In some examples, the audio encoder 210 of the ASR model 200 includes a stack of self-attention layers/blocks, such as conformer blocks. Here, each conformer block includes a series of multi-headed self attention, depth wise convolution and feed-forward layers. The prediction network 220 may have two 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets.

Referring back to FIG. 1, in the example shown, the speakers 10 and the user device 110 may be located within an environment (e g., a room) where the user device 110 is configured to capture and convert speech utterances 120 spoken by the speakers 10 into the audio data 122. For instance, the speakers 10 may correspond to co-workers having a conversation during a meeting and the user device 110 may record and convert the speech utterances 120 into the audio data 122. In turn, the user device 110 may provide the audio data 122 to the diarization model 150 for predicting voice activity indicators 182 for each of the speakers 10 during each of the plurality of output steps. Thus, the diarization model 150 is tasked with processing the audio signal 122 to determine when someone is speaking without specifically determining who is talking via speaker recognition/identification

In some examples, at least a portion of the utterances 120 conveyed in the audio data 122 are overlapping such that at a given instant in time voices of two or more of the speakers 10 are active. Notably, a number N of the multiple speakers 10 may be unknown when the audio data 122 is provided as input to the diarization model 150 and the diarization model 150 may predict the number N of the multiple speakers 10. In some implementations, the user device 110 is remotely located from the speakers 10. For instance, the user device 110 may include a remote device (e.g., a network server) that captures speech utterances 120 from speakers that are participants in a phone call or video conference. In this scenario, each speaker 10 would speak into their own device (e.g., phone, radio, computer, smartwatch, etc.) that captures and provides the speech utterances 120 to the remote user device 110 for converting the speech utterances 120 into the audio data 122. Of course in this scenario, the utterances 120 may undergo processing at each of the user devices and be converted into corresponding audio data 122 that are transmitted to the remote user device 110 which may additionally process the audio data 122 provided as input to the diarization model 150.

In some implementations, the diarization model 150 includes a diarization encoder 160, a latent speaker bottleneck module (LSBM) 170, and a diarization decoder 180. The diarization encoder 160 may include a stack of multi-head self-attention layers, such as conformer layers or transformer layers. The diarization encoder 160 is configured to receive the audio data 122 and encode the audio data 122 into a sequence of audio features 162. The audio data 122 may correspond to a sequence of speech frames such that each audio feature 162 corresponds to a respective speech frame. Each audio feature 162 may be associated with a corresponding time step (e.g., output step) and represent speech content extracted from the audio data 122 during the corresponding time step.

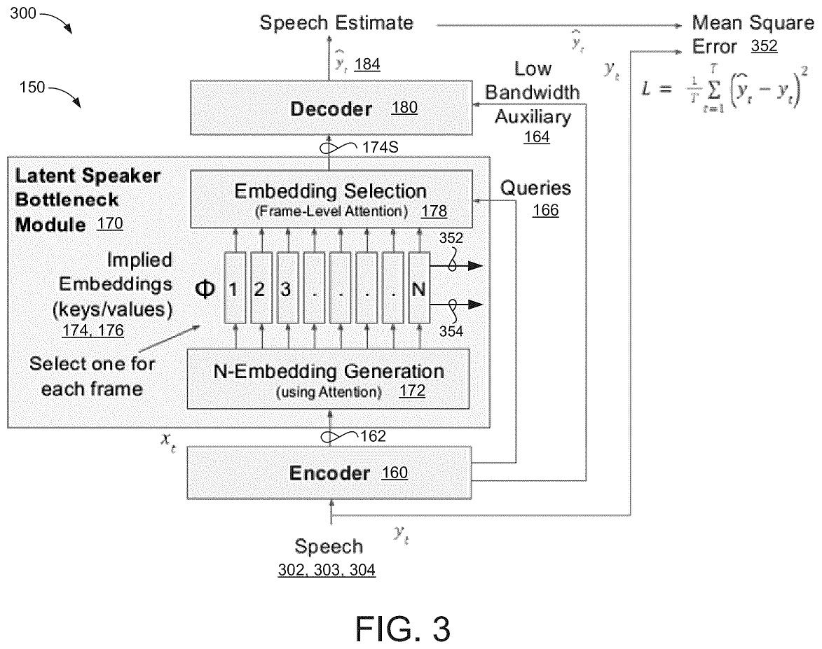

The diarization encoder 160 transmits the sequence of audio features 162 to the LSBM 170. Discussed in greater detail in reference to FIG. 3, in some examples, the LSBM 170 is configured to generate, for each respective output step, a corresponding set of embeddings 174 based on the respective audio feature 162 and select a subset of embeddings 174, 174S from the set of embeddings 174. Here, each output step may correspond to a time step or a respective one or more audio features 162. The corresponding set of embeddings 174 may represent a variety of different speaking styles that may, or may not be, associated with the speech of the respective audio feature 162. Thus, each embedding 174 may be associated with a respective one of the speakers 10 speaking during the conversation. Put another way, each embedding 174 may represent respective speech characteristics that correspond to a particular speaker 10 from the conversation.

To that end, the LSBM 170 is further configured to select, from the corresponding set of embeddings 174, the subset of embeddings 174S that closely resemble the speech from the respective audio feature 162 at each output step. Here, each output step may correspond to a time step or a respective one or more audio features 162. The selected subset of embeddings 174S may include the corresponding embeddings 174 associated with the respective one or more speakers 10 that spoke during the respective speech frame (e.g., respective audio feature 162). In some examples, the LSBM 170 selects the subset of embeddings 174S using a query 166 (FIG. 3) generated by the diarization encoder 160. Moreover, for each respective audio feature 162, the LSBM 170 may generate a corresponding weight 176 for each respective embedding 174 of the set of embeddings 174. The corresponding weight 176 indicates whether the respective embedding 174, and thus the associated speaker 10, was active (i.e., speaking) during the respective audio feature 162. In some implementations, the LSBM 170 generates the corresponding set of embeddings 174 once for each sequence of audio features 162 instead of generating the corresponding set of embeddings 174 for each respective audio feature 162.

The LSBM 170 transmits the subset of embeddings 174S to the diarization decoder 180 which is configured to predict, for each output step, a respective voice activity indicator 182 for each respective speaker 10 of the multiple speakers 10 based on the subset of embeddings 174S selected for the respective audio feature 162. Here, each output step may correspond to a time step or a respective one or more audio features 162. The respective voice activity indicator 182 indicates whether a voice of the respective speaker 10 is active or inactive at the respective output step. The diarization model 150 may use the voice activity indicator 182 at each output step to provide diarization results 190. As shown in FIG. 1, the diarization results 190 include the voice activity indicator 182 (y_{i,t}) of speaker 10 (i) at time step/to show that a first speaker 10 spoke during time steps 1, 2, 5, and 6 while a second speaker 10 spoke during time steps 3, 5, and 6. Accordingly, the voice activity indicator 182 (y_{i,t}) of the diarization results 190 provides per-speaker, per-timestep voice activity results with a value of “0” when the speaker 10 is inactive and a value of “1” when the speaker 10 is active during time step t. As shown at time step (t=4), multiple speakers 10 may be active at the same time. Discussed in greater detail with FIG. 3, the diarization decoder 180 may also generate a corresponding reconstructed speech feature 184 at each output step. The corresponding reconstructed speech feature 184 aims to match the corresponding speech frame of the audio data 122 input to the diarization encoder 160.

In some implementations, the diarization encoder 160 is further configured to sample one or more audio features 162 from the sequence of audio features 162 and generate auxiliary information 164 corresponding to the sampled one or more audio features 162. For example, the diarization encoder 160 may generate ten audio features 162 for respective audio data 122 and sample three of the ten audio features 162. In this example, the auxiliary information 164 corresponds to the three sampled audio features 162. The sampling may include a random sampling. In these implementations, the diarization decoder 180 concatenates the subset of embeddings 174S selected by the LSBM 170 with the auxiliary information 164 generated by the diarization encoder 160. Here, the diarization decoder 180 predicts the respective voice activity indicator 182 for each respective speaker of the two or more speakers based on the concatenation.

FIG. 3 shows an example training process 300 of the diarization model 150. The training process 300 includes updating parameters of any combination of components of the diarization model 150 based on any combination of losses derived by the training process 300. For instance, the training process 300 may only update parameters of one or more components of the LSBM 170. The training process 300 obtains training samples 302 to train the LSBM 170. The training samples 302 may include unlabeled training samples 302 and/or labeled training samples 302. Each unlabeled training sample 302 includes audio only data that is not paired with any corresponding text or ground-truth label. Each labeled training sample 302, includes audio data paired with a corresponding ground-truth label 304 representing a target output. The target output may include a target transcription, a target weight, a target speech feature, and/or a target speaker label. Moreover, each training sample 302 characterizes speech spoken by one or more speakers of a conversation and includes a sequence of speech frames 303.

In some implementations, initially the training process 300 trains the diarization model 150 in an end-to-end manner (e.g., training all components on derived losses) using the unlabeled training data 302. In particular, the training process 300 may initially train the diarization model 150 using the unlabeled training data 302 on a mean square error loss 352. Thereafter, the training process 300 may train only the LSBM 170 using labeled training data 302 on a selection loss 354 and/or a weight variance loss 356 without training the diarization encoder 160 or the diarization decoder 180.

For each respective training sample 302, the diarization encoder 160 generates a sequence of audio features 162 based on the sequence of speech frames 303. Here, the sequence of speech frames 303 may include T frames and D dimensions and the sequence of audio features 162 also includes T frames. In some examples, the LSBM 170 includes an embedding generator 172 and a selector 178. The embedding generator 172 generates the corresponding set of embeddings 174 based on the sequence of audio features 162. The set of embeddings 174 includes N fixed dimensional embeddings. The number of embeddings 174 in the set of embeddings 174 may correspond to the number of speakers in the conversation. The embedding generator 172 may generate the corresponding set of embeddings 174 for each respective audio feature 162 of the sequence of audio features 162 or once for each sequence of audio features 162. Moreover, the embedding generator 172 may include a stack of multi-head self-attention layers (e.g., conformer or transformer layers) that generate the corresponding set of embeddings 174 using attention. The embedding generator 172 may generate the corresponding set of embeddings 174 according to.

$${ϕ}_{i} = \frac{{\sum }_{t = 1}^{T} {w}_{it} {x}_{t}}{{\sum }_{t = 1}^{T} {w}_{it}} \qquad ( 1 )$$

In Equation 1, ϕᵢ represents the embedding vector for the corresponding set of embeddings 174, xₜ represents the audio feature 162 of the sequence of audio features 162 at time frame t, and wᵢₜ represents a weight 176 applied to the embedding i at time frame t. That is, the embedding generator 172 generates or applies a corresponding weight 176 to each respective embedding 174 of the set of embeddings 174 at each time frame (i.e., output step).

Each weight 176 may include a binary output (e.g., 0 or 1) whereby one binary output indicates that the respective embedding 174 is active and the other binary output indicates that the respective embedding 174 is not active. Since each embedding 174 may represent a speaking style, voice profile, or voice characteristics, the corresponding weight 176 indicates whether a particular speaker associated with the respective embedding is currently speaking at the corresponding time step. Thus, at a respective time step where only one speaker is speaking, only one of the weights 176 should be active while the others are inactive. Alternatively, at another respective time step where multiple speakers are speaking (e.g., overlapping speech), multiple of the weights 176 may be active.

The selector 178 is configured to select the subset of embeddings 174S from the set of embeddings 174 and output the subset of embeddings 174S to the diarization decoder 180. In some implementations, the diarization encoder 160 generates at each output step (e.g., at each time frame or at each audio feature 162) a query 166 whereby the set of embeddings 174 and/or the corresponding weights 176 represent key value pairs. As such, the selector 178 may select the subset of embeddings 174S by using the query 166 to process the relevant key value pairs at the corresponding output step.

The diarization decoder 180 may also receive the auxiliary information 164 from the diarization encoder 160 in addition to the subset of embeddings 174S. That is, the diarization encoder 160 may generate the auxiliary information 164 at each output step (i.e., at each time step or at each audio feature 162) by sampling one or more of the audio features 162. To that end, the diarization decoder 180 may reconstruct the corresponding speech frame input 303 to the diarization encoder 160 by combining the auxiliary information 164 with the subset of embeddings 174S to output a reconstructed speech frame 184. That is, for each output frame, the diarization decoder 180 combines the information from the currently selected embedding (e.g., subset of embeddings 174S) and the auxiliary information 164 to improve the reconstructed speech frame 184. The training process 300 may determine a mean square error loss (i.e., discriminative loss, such as wav2vec) 352 based on the reconstructed speech frame 184 and the corresponding speech frame 303. That is, the training process 300 may compare each reconstructed speech frame 184 output by the diarization decoder 180 with the corresponding speech frame 303 to determine the mean square error loss 352 and repeat this for every speech frame 303 of each training sample 302. Thus, the training process 300 may determine the mean square error 352 loss according to.

$$L = \frac{1}{T} {\sum }_{t = 1}^{T} {( - {y}_{t} )}^{2} \qquad ( 2 )$$

In Equation 2, [symbol] represents the reconstructed speech frame 184 at time t, and yₜ represents the corresponding speech frame 303 at time t. The training process 300 trains the diarization model 150 on the mean square error loss 352 determined for each training sample 302. In some examples, the training process 300 initially trains the diarization model 150 in an end-to-end manner on the mean square error loss 352 using only unlabeled training samples 302.

Moreover, the training process 300 trains the LSBM 170 to learn how to generate accurate weights 176 for the set of embeddings 174. In some configurations, after the training process 300 trains the diarization model 150 on the unlabeled training samples 302, the training process 300 further trains the LSBM 170 on labeled training samples 302 without training the diarization encoder 160 or the diarization decoder 180 on the selection loss 354 and/or the weight variance loss 356.

More specifically, the training process 300 uses the selection loss 354 to teach the LSBM 170 to generate each weight 176 to have a value of one or zero (or close to one or zero) which indicates whether a respective speaker is currently speaking or not. In a scenario where only one speaker is speaking, the training process 300 teaches the LSBM 170 to generate only one of the weights 176 as being active (e.g., value of one) which indicates only one speaker is currently speaking. Teaching the LSBM 170 to generate accurate weights 176 enables the LSBM 170 to select the subset of embeddings 174S to accurately reflect who is speaking at each input frame. To that end, the training process 300 may train the embedding generator 172 to generate weights 176 with values of one or zero by performing soft attention across the sequence of speech frames 303 (or sequence of audio features 162) or restricting each weight 176 to have value of either one or zero. In particular, the embedding generator 172 may perform soft attention according to.

$${w}_{it} = \frac{exp ( α {q}_{t} \cdot {k}_{i} )}{{\sum }_{j = 1}^{N} exp ( α {q}_{t} \cdot {k}_{j} )} \qquad ( 3 )$$

In Equation 3, qₜ represents the query vector (e.g., query 166) at time t, kᵢ represents the ith of the N key vectors, and α represents the scaling factor. The key vectors (e.g., set of embeddings 174 and/or weights 176) can be learned as parameters during the training process 300. For example, the embedding generator 172 may generate the set of embeddings 174 and the corresponding weights 176 as a linear transformation of the sequence of audio features 162.

In some examples, the training process 300 may train the embedding generator 172 to output weights 176 with values of 0 or 1 by setting the scaling factor a to a large number near infinity. The scaling factor is used by the embedding generator 172 to perform soft attention across the sequence of speech frames 303. With the large scaling factor small differences across the key value pairs (e.g., set of embeddings 174 and/or weights 176) causes large differences in exponent results (e.g., weights 176). As such, the large scaling factor results in the embedding generator 172 outputting one weight 176 with a value near 1 while outputting the other weights 176 with a value near 0. However, the large scaling factor may prevent convergence during the training process 300. As such, the training process 300 may initially set the scaling factor at a first value, such as 1, to promote convergence initially during training and then continuously increase the scaling factor as the training process 300 progresses training the LSBM 170.

Moreover, the training process may constrain the query 166 and key dot product scores using variance normalization to prevent the dot product scores from simply reducing as the scaling factor increases. In some instances, the training process 300 teaches the embedding generator 172 to output weights 176 with a corresponding value of 0 or 1 based on stochastic or noise interpretation of the sequence of audio features 162. The training process 300 may determine the selection loss 354 at each output step by comparing the generated set of embeddings 174 and/or the corresponding weights 176 to the corresponding ground-truth transcription 304. Thus, determining the selection loss 354 and training the LSBM 170 on the selection loss 354 for each labeled training sample 302 teaches the embedding generator 172 to generate corresponding weights 176 with values of 0 or 1.

In some implementations, the training process 300 trains the LSBM 170 to learn that the corresponding weights 176 for the set of embeddings 174 should not change unless there is a speaker change (i.e., speaker turn). Put another way, the corresponding weights 176 generated for each speech frame 303 or audio feature 162 should not change for each frame unless there is a speaker turn. As such, the training process 300 may determine weight variance loss 356 that represents how much the corresponding weights 176 generated by the embedding generator 172 vary at each frame. For instance, the training process 300 may determine the weight variance loss 356 between adjacent frames according to.

$${L}_{v} = \frac{1}{TN} {\sum }_{t = 2}^{T} {\sum }_{i = 1}^{N} {( {w}_{it} - {w}_{i ( t - 1 )} )}^{2} \qquad ( 4 )$$

Thais, the training process 300 may compare the corresponding weights 176 between each adjacent frame to determine the weight variance loss 356. That is, the training process 300 may determine the weight variance loss 356 based on adjacent pairs of corresponding sets of weights 176. Moreover, the training process 300 may further determine the weight variance loss 356 by comparing the corresponding weights to the corresponding ground truth label 304. Thus, the weight variance loss 356 discourages the embedding generator 172 from updating the corresponding weights 176, and thus select a different subset of embeddings 174S, across adjacent frames. Moreover, the weight variance loss 356 encourages the embedding generator 172 to only update the corresponding weights 176, and thus select the different subset of embeddings 174S, across adjacent frames only when it is beneficial to capture a speaker change or speaker turn. Thus, training the LSBM 170 on the weight variance loss 356 may present a trade off between the cost of switching speakers versus the benefit of producing a more accurate output. Put another way, training on the weight variance loss 356 may teach the embedding generator 172 to not update the corresponding weights 176 unnecessarily when a speaker turn has not occurred. However, in some scenarios, this may also cause the embedding generator 172 to inadvertently fail to update the corresponding weights 176 when an actual speaker turn has occurred.

Advantageously, after the training process 300 trains the diarization model 150, the training process 300 may use the trained diarization model 150 to label unlabeled training data and use this labeled training data to train another model in a teacher-student training manner. Notably, speaker diarization has typically been data poor. That is, there is not a lot of training data, especially labeled training data which includes labels at each segment of speech indicating which speaker is speaking. As such, the trained diarization model 150 may label unlabeled diarization training data (e.g., generate labeled diarization training data from unlabeled diarization training data) that the training process 300 uses to train another model on, such as a large language model (LLM) or a multimodal LLM. For instance, multimodal LLMs may receive textual prompts and audio as input and generate textual outputs. Thus, multimodal LLMs may be trained to output diarization results indicating which speaker from a conversation spoke each term from a conversation based on inputting a textual prompt, such as “diarize the following conversation,” and corresponding audio data. Other textual prompts may include “diarize the following conversation between Bob and Mark” or “diarize the following conversation between a doctor and a patient” such that the multimodal LLM outputs specific speaker labels (e.g., Bob, Mark, doctor, patient, etc.) for each speech segment.

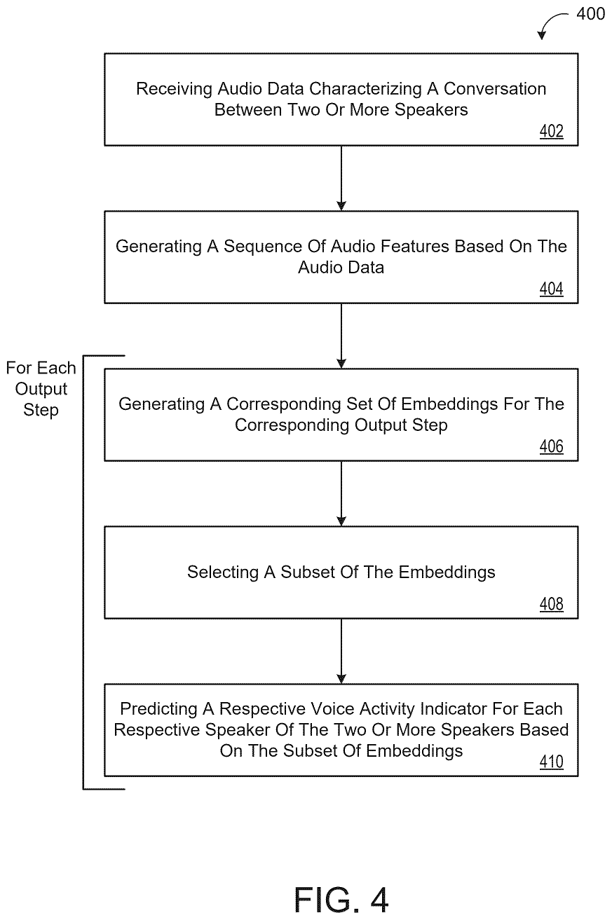

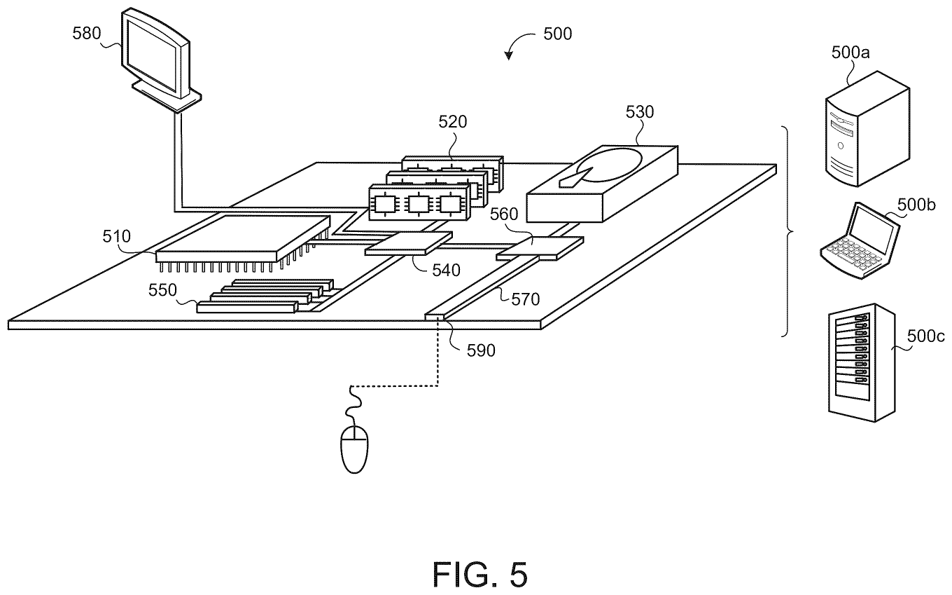

FIG. 4 is a flowchart of an example arrangement of operations for a computer-implemented method 400 of performing unsupervised speaker diarization using a latent speaker bottleneck module 170. The method 400 may execute on data processing hardware 510 (FIG. 5) using instructions stored on memory hardware 520 (FIG. 5) that may reside on the user device 110 and/or the remote system 140 of FIG. 1 each corresponding to a computing device 500 (FIG. 5).

At operation 402, the method 400 includes receiving, as input to a speaker diarization model 150, audio data 122 characterizing a conversation between two or more speakers 10. At operation 404, the method 400 includes generating a sequence of audio features 162 based on the audio data 122 using a diarization encoder 160 of the speaker diarization model 150. For each output step of a plurality of output steps, the method 400 performs operations 406-410. At operation 406, the method 400 includes generating a corresponding set of embeddings 174 for the corresponding output step using a latent speaker bottleneck module (LSBM) 170 of the speaker diarization model 150. At operation 408, the method 400 includes selecting a subset of the embeddings 174, 174S for the corresponding output step from the set of embeddings 174 using the LSBM 170. At operation 410, the method 400 includes predicting, using a diarization decoder 180 of the speaker diarization model 150, a respective voice activity indicator 182 for each respective speaker of the two or more speakers based on the subset of the embeddings 174S for the corresponding output step. The respective voice activity indicator 182 indicates whether a voice of the respective speaker 10 is active or inactive at the corresponding output step.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A speaker diarization model comprising:
a diarization encoder configured to:
receive, as input, audio data characterizing a conversation between two or more speakers; and
generate a sequence of audio features based on the audio data;
a latent speaker bottleneck module (LSBM) configured to:
receive, as input, the sequence of audio features generated by the diarization encoder; and
for each of a plurality of output steps:
generate a corresponding set of embeddings for the corresponding output step; and
select a subset of the embeddings for the corresponding output step; and
a diarization decoder configured to:
receive the subset of the embeddings selected by the LSBM; and
at each output step, predict a respective voice activity indicator for each respective speaker of the two or more speakers based on the subset of the embeddings selected for the corresponding output step, the respective voice activity indicator indicating whether a voice of the respective speaker is active or inactive at the corresponding output step.

2. The speaker diarization model of claim 1, wherein the diarization encoder is further configured to:
sample one or more audio features from the sequence of audio features; and
generate auxiliary information based on the sampled one or more audio features.

3. The speaker diarization model of claim 2, wherein the diarization decoder is further configure to:
concatenate the subset of embeddings selected by the LSBM with the auxiliary information generated by the diarization encoder,
wherein the diarization decoder predicts the respective voice activity indicator for each respective speaker of the two or more speakers further based on the concatenation.

4. The speaker diarization model of claim 1, wherein, using a training process, the speaker diarization model is trained on unlabeled training samples each comprising a sequence of speech features, for each respective speech feature the training process comprises:
generating, using the speaker diarization model, a corresponding reconstructed speech feature;
determining a mean square error loss based on the respective speech feature and the corresponding reconstructed speech feature; and
training the speaker diarization model end-to-end on the mean square error loss.

5. The speaker diarization model of claim 4, wherein after training the speaker diarization model on the mean square error loss the training process trains the LSBM on labeled training samples each paired with a corresponding ground truth label, for each respective labeled training sample the training process comprises:
generating, using the diarization encoder, a corresponding sequence of audio features; and
generating, using the LSBM, a corresponding set of embeddings based on the corresponding sequence of audio features; and
generating, using the LSBM, a corresponding weight for each respective embedding of the corresponding set of embeddings.

6. The speaker diarization model of claim 5, for each respective labeled training sample the training process further comprises:
determining a selection loss based on the corresponding weight generated for each respective embedding of the corresponding set of embeddings and the corresponding ground truth label; and
training the LSBM on the selection loss to teach the LSBM to generate binary weights.

7. The speaker diarization model of claim 5, for each respective labeled training sample the training process further comprises:
determining a weight variance loss based on adjacent pairs of corresponding sets of weights, and
training the LSBM on the weight variance loss to teach the LSBM to not update the corresponding weight generated for each respective embedding of the corresponding set of embeddings when no speaker turn occurs.

8. The speaker diarization model of claim 1, wherein, using a training process, the speaker diarization model generates labeled training data for speaker diarization from unlabeled training data, the training process, using the labeled training data, teaches another model to learn speaker diarization.

9. The speaker diarization model of claim 1, wherein at least a portion of the audio data comprises overlapping speech.

10. The speaker diarization model of claim 1, wherein a number of the two or more speakers is unknown when the audio data is received.

11. A computer-implemented method executed on data processing hardware that causes the data processing hardware to perform operations comprising:
receiving, as input to a speaker diarization model, audio data characterizing a conversation between two or more speakers;
generating, using a diarization encoder of the speaker diarization model, a sequence of audio features based on the audio data; and
at each output step of a plurality of output steps:
generating, using a latent speaker bottleneck module (LSBM) of the speaker diarization model, a corresponding set of embeddings for the corresponding output step;
selecting, using the LSBM, a subset of the embeddings for the corresponding output step from the corresponding set of embeddings; and
predicting, using a diarization decoder of the speaker diarization model, a respective voice activity indicator for each respective speaker of the two or more speakers based on the subset of the embeddings selected for the corresponding output step, the respective voice activity indicator indicating whether a voice of the respective speaker is active or inactive at the corresponding output step.

12. The computer-implemented method of claim 11, wherein the operations further comprise:
sampling, using the diarization encoder, one or more audio features from the sequence of audio features; and
generating, using the diarization encoder, auxiliary information based on the sampled one or more audio features.

13. The computer-implemented method of claim 12, wherein the operations further comprise:
concatenating, using the diarization decoder, the subset of embeddings selected by the LSBM with the auxiliary information generated by the diarization encoder,
wherein predicting the respective voice activity indicator for each respective speaker of the two or more speakers is further based on the concatenation.

14. The computer-implemented method of claim 11, wherein the operations further comprise training the speaker diarization model on unlabeled training samples each comprising a sequence of speech features by, for each respective speech feature:
generating, using the speaker diarization model, a corresponding reconstructed speech feature;
determining a mean square error loss based on the respective speech feature and the corresponding reconstructed speech feature; and
training the speaker diarization model end-to-end on the mean square error loss.

15. The computer-implemented method of claim 14, wherein, after training the speaker diarization model on the mean square error loss, the operations further include training the LSBM on labeled training samples each paired with a corresponding ground truth label by, for each respective labeled training sample:
generating, using the diarization encoder, a corresponding sequence of audio features; and
generating, using the LSBM, a corresponding set of embeddings based on the corresponding sequence of audio features; and
generating, using the LSBM, a corresponding weight for each respective embedding of the corresponding set of embeddings.

16. The computer-implemented method of claim 15, wherein the operations further comprise, for each respective labeled training sample:
determining a selection loss based on the corresponding weight generated for each respective embedding of the corresponding set of embeddings and the corresponding ground truth label; and
training the LSBM on the selection loss to teach the LSBM to generate binary weights.

17. The computer-implemented method of claim 15, the operations further comprise, for each respective labeled training sample:
determining a weight variance loss based on adjacent pairs of corresponding sets of weights; and
training the LSBM on the weight variance loss to teach the LSBM to not update the corresponding weight generated for each respective embedding of the corresponding set of embeddings when no speaker turn occurs.

18. The computer-implemented method of claim 11, wherein the operations further comprise:
generating, using the speaker diarization model, labeled training data for speaker diarization from unlabeled training data; and
training another model to learn speaker diarization using the labeled training data.

19. The computer-implemented method of claim 11, wherein at least a portion of the audio data comprises overlapping speech.

20. The computer-implemented method of claim 11, wherein a number of the two or more speakers is unknown when the audio data is received.
